(19) United States
(12) Patent Application Publication
(10) Pub. No.: US 2009/0126470 A1
(43) Pub. Date: May 21, 2009

(54) SPECIMEN INSPECTING APPARATUS AND STIRRING APPARATUS

(75) Inventors: Hirohisa Miyamoto, Kanagawa (JP); Takeshi Kinpara, Kanagawa (JP); Yoshiaki Nakamura, Kanagawa (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/268,483

(22) Filed: Nov. 11, 2008

(30) Foreign Application Priority Data
Nov. 15, 2007 (JP) 2007-297089
Mar. 26, 2008 (JP) 2008-080810

(51) Int. Cl. G01N 1/28

(52) U.S. Cl. 73/64.56; 73/863.21

(57) ABSTRACT

A specimen inspecting apparatus includes a member that forms a flow path; a first solution supplying unit that supplies a first solution containing a specimen to the flow path; a selecting unit that selects a measuring item of the specimen to be inspected; a second solution supplying unit that supplies a second solution corresponding to the measuring item to the flow path; a separating unit that can separate a part of a mixture solution with which the first solution and the second solution in the flow path; an operation control unit that controls the separating unit corresponding to a measuring item selected by the selecting unit, to separate a portion of the mixture solution of which mixture rate is not constant; and a inspecting unit communicated to the flow path at a downstream position of the separating unit, and irradiates light to the mixture solution except the separated mixture solution to inspect the specimen.

### CROSS-REFERENCE TO RELATED APPLICATIONS

This application is based upon and claims the benefit of priority from the prior Japanese Patent Application No. 2007-297089, filed on Nov. 15, 2007; and Japanese Patent Application No. 2008-080810, filed on Mar. 26, 2008, the entire contents of both of which are incorporated herein by reference.

### BACKGROUND OF THE INVENTION

1. Field of the Invention

The present invention relates to a specimen inspecting apparatus and a stirring apparatus.

2. Description of the Related Art

There are specimen inspecting apparatuses that measure various biological materials such as ions, gas components, and biochemical components contained in a specimen of a living body fluid such as blood and urine. A. main type of conventional specimen inspecting apparatuses is a relatively large unit, which is installed in a facility of a large hospital or the like that manages blood supplies and is capable of measuring a few hundred types of items at a maximum.

Recently, there has been a high demand for developing a compact specimen inspecting apparatus, and it has been required to develop a mechanism that detects in high sensitivity a biological material from an extremely small amount of a specimen.

As one of such techniques, JP-A 2006-217818 (KOKAI) discloses a technique of optically measuring a specimen, by supplying a mixture solution of a specimen and a reagent to a fine flow path.

JP-A 2006-217818 (KOKAI) describes the following. In mixing two reagents using a Y-shaped flow path, even when these reagents are simultaneously supplied, a mixture rate is not stable at a header part of the mixture solution, and therefore, it is desirable to omit this header part and supply the mixture solution to the next stage after the mixture rate is stabilized.

Further, enzyme reactions are widely used to inspect a specimen, particularly, to measure various types of biochemical components. A specimen and an inspection reagent start when the two liquids are mixed. Therefore, the specimen and the inspection reagent need to be uniformly mixed in a short time.

Generally, when the amount of a solution to be handled is small, it becomes difficult to mix the specimen and the inspection reagent. In the fine flow path (with a diameter of about 1 millimeter or smaller) handled in a fine chemical analysis system, an aqueous solution flows in a laminar flow. Therefore, a mixture rate depends on dispersion unless a positive mixing unit is provided. Even if the amount of a handled solution is fine, a long time is necessary until a mixing is finished, in the mixing depending on molecular dispersion.

As a positive mixing method, a stirrer driving method using magnetic force is often used. For example, as disclosed in JP-A 2007-054817 (KOKAI), a stirrer is rotated magnetically in a fine space, thereby mixing a solution.

However, JP-A 2006-217818 (KOKAI) does not disclose a detailed method of omitting the header part of the mixture solution (a part where a mixture rate is not stable). Therefore, there is a problem that a high-precision inspection cannot be performed with a very small amount of the specimen.

According to the system of mixing by rotating the stirrer with magnetic force as disclosed in JP-A 2007-054817 (KOKAI), a rotating mechanism configured by a magnet and its motor to rotate the stirrer are essential at the outside. Therefore, this system becomes expensive.

The stirrer and the rotating mechanism are set to correspond to one to one. Therefore, to simultaneously rotate plural mixing mechanisms, external rotating mechanisms of the same number of the mixing mechanisms are necessary. Accordingly, it becomes difficult to make compact and integrate the devices, and this results in high cost.

### SUMMARY OF THE INVENTION

According to one aspect of the present invention, a specimen inspecting apparatus includes a member that forms a flow path; a first solution supplying unit that supplies a first solution containing a specimen to the flow path; a selecting unit that selects a measuring item of the specimen to be inspected; a second solution supplying unit that supplies a second solution corresponding to the measuring item to the flow path; a separating unit that can separate a part of a mixture solution with which the first solution and the second solution in the flow path; an operation control unit that controls the separating unit corresponding to a measuring item selected by the selecting unit, to separate a portion of the mixture solution of which mixture rate is not constant; and a inspecting unit communicated to the flow path at a downstream position of the separating unit, and irradiates light to the mixture solution except the separated mixture solution to inspect the specimen.

According to another aspect of the present invention, a stirring apparatus includes a stirring bath that is provided in a flow path through which a first solution containing a specimen and a second solution corresponding to a measuring item of the specimen to be inspected flow, and that accommodates a mixture solution between the first solution and the second solution; a stirrer that is arranged within the stirring bath; and a stirring control unit that reciprocates the stirrer by control of electromagnetic force within the stirring bath, thereby stirring the mixture solution.

### BRIEF DESCRIPTION OF THE DRAWINGS

FIG. 1 is a schematic bock diagram illustrating a configuration of a specimen inspecting apparatus according to a first embodiment of the present invention;

FIG. 2 is a schematic diagram illustrating a configuration of the mixing cartridge;

FIGS. 3A and 3B are diagrams illustrating test results of a pump operation performance;

FIG. 4 is a block diagram illustrating a functional configuration of a control unit;

FIGS. 5A and 5B are schematic diagrams illustrating an example of parameters stored in a measuring item DB shown in FIG. 4;

FIG. 6 is a schematic diagram illustrating a separation mechanism;

FIG. 7 is a schematic diagram illustrating a configuration of a stirring apparatus of a mixing cartridge according to a second embodiment of the present invention;

FIG. 8 is a schematic diagram illustrating one example of a circuit configuration of stirring control units;

FIG. 9 is a schematic diagram illustrating the stirring apparatus when in operation;

FIG. 10 is a schematic diagram illustrating the stirring apparatus when in operation, when a ferromagnetic material is used as a stirrer;

FIGS. 11 to 14 are schematic diagrams illustrating a stirring apparatus according to a modification;

FIG. 15 is a schematic diagram illustrating one example of a stirring apparatus;

FIG. 16 is a graph of a result of mixing; and

FIG. 17 is a schematic diagram illustrating a stirring apparatus according to a third embodiment of the present invention.

### DETAILED DESCRIPTION OF THE INVENTION

Exemplary embodiments of a specimen inspecting apparatus and a stirring apparatus according to the present invention will be explained below in detail with reference to the accompanying drawings.

In a specimen inspecting apparatus using an extremely small amount of a specimen, it is important to obtain a mixture solution having a stable mixing of a specimen and a reactive reagent within a fine flow path. When it is attempted to obtain a mixture solution of a specimen and various reactive reagents, a large difference occurs corresponding to a measuring item (a reactive reagent used for a measurement or a mixture rate of the reactive reagent, or an operation delay of a pump that supplies a reagent) to stabilize (to mix homogeneously) the mixture solution within the fine flow path. That is, for each measuring item, the amount of an unstable and uncertain mixture solution part before obtaining a stable mixture solution is different depending on a measuring item or a mixture rate of the solution. Therefore, an uncertain mixture solution part is also different corresponding to this different amount. According to the present invention, the uncertain mixture solution part can be separated by only a proper amount corresponding to the measuring item.

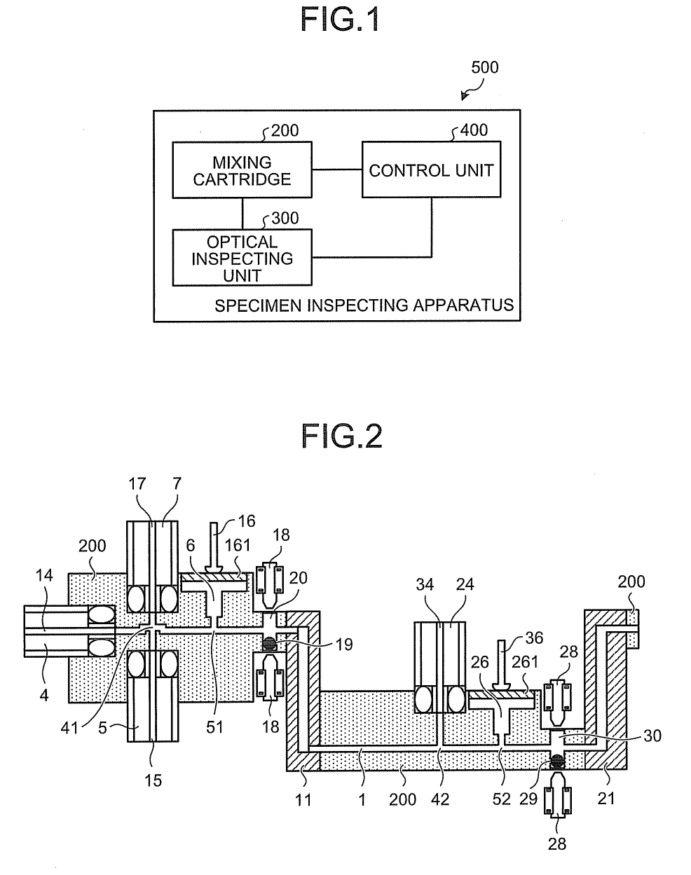

First, a first embodiment of the present invention is explained with reference to FIG. 1 to FIG. 6. FIG. 1 is a schematic bock diagram illustrating a configuration of a specimen inspecting apparatus 500 according to the first embodiment. The specimen inspecting apparatus 500 includes a mixing cartridge 200 that mixes a specimen with a reactive reagent, an optical inspecting unit 300 as an inspecting unit optically inspecting a solution mixed by the mixing cartridge 200, and a control unit 400 that controls the operations of the mixing cartridge 200 and the optical inspecting unit 300.

FIG. 2 is a schematic diagram illustrating a configuration of the mixing cartridge 200. As shown in FIG. 2, the mixing cartridge 200 includes a first photometric cell 11 and a second photometric cell 21 that are used by the optical inspecting unit 300 to perform an optical inspection, with a fine flow path 1 formed inside the mixing cartridge 200. A first reagent tank 4, a specimen tank 5, an oil tank 7, a second reagent tank 24, a first waste tank 6, and a second waste tank 26 are communicated in the fine flow path 1. The fine flow path 1 and a path communicated to the tanks 4, 5, 7, and 24 that supply liquid, or the first and second waste tanks 6 and 26 are formed in the mixing cartridge 200.

A first reagent pump 14 that functions as a second solution supplying unit supplying a first reagent to the fine flow path is provided in the first reagent tank 4. A specimen pump 15 that functions as a first solution supplying unit that supplies a first solution including a specimen to the fine flow path 1 is provided in the specimen tank 5. An oil pump 17 is provided in the oil tank 7. A second reagent pump 34 is provided in the second reagent tank 24. The pumps 14, 15, 17, and 34 are syringe type pumps, which press out a solution stored in a corresponding tank to the fine flow path 1. The first reagent tank 4, the specimen tank 5, and the oil tank 7 are arranged to merge at the same point of the fine flow path 1. The first reagent, the specimen, and the oil flow together to the fine flow path 1 at a merging point 41. The first waste tank 6 is branched and communicated at the downstream point of the merging point 41 of the first reagent, the specimen, and the oil in the fine flow path. The first waste tank 6 includes a first suction pump 16 that functions as a pressure control unit, and can separate the solution within the fine flow path 1 to the first waste tank 6. The first suction pump 16 and the first waste tank 6 constitute a separating unit.

A stirring bath 20 arranged with a first magnet 19 as a stirrer used to stir the solution is provided in the fine flow path 1 at the downstream of a branch point 51 of the first waste tank 6 and the fine flow path 1. A first stirring control unit 18 is arranged around the stirring bath 20. The first stirring control unit 18 includes a pair of electromagnets, and reciprocates the first magnet 19 within the stirring bath 20 by alternately inverting directions of currents passing to the electromagnets.

The first photometric cell 11 performing the optical inspection by irradiating light is provided at the downstream of the first magnet 19 (the stirring bath 20). Preferably, a material having a high optical transmissivity is used for the first photometric cell 11 to avoid generating an inspection error. The optical inspecting unit 300 built in the specimen inspecting apparatus 500 inspects the mixture solution reaching the first photometric cell 11.

The second reagent tank 24 communicated to the fine flow path 1 is provided at the downstream of the first photometric cell 11. The second waste tank 26 communicated with the fine flow path 1 in a branch is provided at the downstream of a merging point 42 of the second reagent tank 24 and the fine flow path 1, like the case of the first reagent. A stirring bath 30 including a second magnet 29 as a stirrer used to stir the solution is provided in the fine flow path 1 at the downstream of a branching point 52 of the second waste tank 26 and the fine flow path 1. A second stirring control unit 28 that reciprocates the second magnet 29 within the stirring bath 30 in a similar mechanism to that of the first stirring control unit 18 is provided around the stirring bath 30. The second photometric cell 21 that performs the optical inspection is provided at the downstream of the second magnet 29 (the stirring bath 30). Preferably, the second photometric cell 21 also uses a material having a high optical transmissivity to avoid generating an inspection error, like the first photometric cell 11. The optical inspecting unit 300 built in the specimen inspecting apparatus 500 inspects the mixture solution reaching the second photometric cell 21.

The operation of the specimen inspecting apparatus 500 according to the first embodiment is explained next. The specimen inspecting apparatus 500 holds a specimen as a living body fluid such as blood and urine, in the specimen tank 5, and the specimen pump 15 presses out the specimen to the fine flow path 1. The specimen inspecting apparatus 500 selectively stores a first reagent corresponding to an item of the specimen to be inspected, in the first reagent tank 4, and the first reagent pump 14 supplies the first reagent to the fine flow path 1. Two reactive reagents are necessary corresponding to a measuring time. Therefore, the second reagent pump 34 can supply the second reagent held in the second reagent tank 24, to the fine flow path 1, separately from the first reagent. Both the first reagent and the specimen are simultaneously supplied to the fine flow path 1, and merged and mixed in the fine flow path 1.

However, the pump driving operation generates a time difference between the time when the pump receives an operation signal and the time when the pump reaches a steady operation to give a predetermined flow speed. The time difference has a variation in the predetermined flow speed given by the pump. A mixture solution supplied by the time when both the specimen pump 15 and the first reagent pump 14 reach the steady operation is an uncertain mixture solution of which mixture rate is not stable. Therefore, this uncertain mixture solution cannot be used for a measurement, and needs to be separated from the fine flow path 1. Accordingly, this uncertain mixture solution is separated from the fine flow path 1 into the first waste tank 6. First, the first suction pump 16 sets the first waste tank 6 to become at a negative pressure before the specimen and the first reagent are supplied. The pressure is set to become the atmospheric pressure simultaneously with the reaching of the uncertain mixture solution to the branching point of the fine flow path 1 and the first waste tank 6. The first suction pump 16 has a separation mechanism of the solution as follows. A rubber sheet 161 is fixed to one end of the first waste tank 6 to block this part. By externally pressing down the rubber sheet 161, the pressure inside the first waste tank 6 is set to a negative pressure. By releasing the pressing down of the rubber sheet 161 and returning the internal pressure to the atmospheric pressure, the uncertain mixture solution is removed. Consequently, the solution at the uncertain mixture rate is introduced to the first waste tank 6, and can be branched or separated from the fine flow path 1.

The mixture solution of the first reagent and the specimen after removing the uncertain mixture solution is carried to the stirring bath 20 including the first magnet 19 within the fine flow path 1. The first stirring control unit 18 operates (reciprocally moves within the stirring bath 20) the first magnet 19 with fine movements within the stirring bath 20, thereby stirring the first reagent and the specimen to promote reaction. The specimen pump 15 and the first reagent pump 14 stop supplying the liquid after performing the driving operation during a predetermined time. Thereafter, the oil pump 17 supplies the oil (not particularly limited so long as the solution is not mixed with water) within the oil tank 7 to the fine flow path 1, thereby carrying the mixture solution. The oil pump 17 is driven to supply the oil to carry the mixture solution until when the first photometric cell 11 provided in the fine flow path 1 is filled with the mixture solution.

After the optical inspecting unit 300 finishes the inspection by the optical method, the oil pump 17 is driven again to carry the mixture solution. When the mixture solution reaches the second reagent tank 24, the second reagent pump 34 starts supplying the second reagent.

Same as the mixing of the first reagent and the specimen, a second suction pump 36 separates the solution, of which mixture rate of the mixture solution and the second reagent is uncertain, from the fine flow path to the second waste tank 26. After this, the second magnet 29 and the second stirring control unit 28 stir the mixture solution, thereby promoting the mixing of the mixture solution. Thereafter, when the second photometric cell 21 provided within the fine flow path 1 is filled with the mixture solution, the optical inspecting unit 300 performs the optical inspection again.

Depending on measuring items, a specimen is inspected using only one reagent. In this case, a configuration concerning the mixing of the second reagent is not necessary. While a syringe pump is used to supply the liquid, a type of the pump is not particularly limited when the pump can supply the liquid such as the plunger system and the piezoelectric system.

Furthermore, to decrease an inspection error due to a mixing of other specimen into the specimen to be inspected, it is considered suitable to replace for each specimen parts brought into contact with the specimen such as the mixing cartridge 200 constituting the specimen tank 5, the first and second waste tanks 6 and 26, the first and second magnets 19 and 29, and the fine flow path 1. The first and second reagent tanks 4 and 24 and the oil tank 7 can be also replaced for each specimen.

While the first and second magnets 19 and 29 are used as the stirrers to mix the mixture solution, and also the first and second stirring control units 18 and 28 are used in the first embodiment, other mechanism can be also used. While the oil pump 17 is used to carry the mixture solution, other methods can be also used to obtain the effects of the present invention.

In FIG. 2, while the first magnet 19 (the stirring bath 20) that stirs the solution is arranged at the downstream of the branch point of the first waste tank 6, the first magnet 19 (the stirring bath 20) can be arranged either at the downstream or the upstream of the branch point of the first waste tank 6. However, when the solution of which mixture rate is uncertain reaches the part (the stirring bath 20) including the first magnet 19 stirring the solution, some error occurs in the mixture rate of the mixture solution used to perform the inspection. Therefore, preferably, the branch point of the first waste tank 6 is present at the upstream of the first magnet 19 (the stirring bath 20). This similarly applies to the configuration of mixing the second reagent.

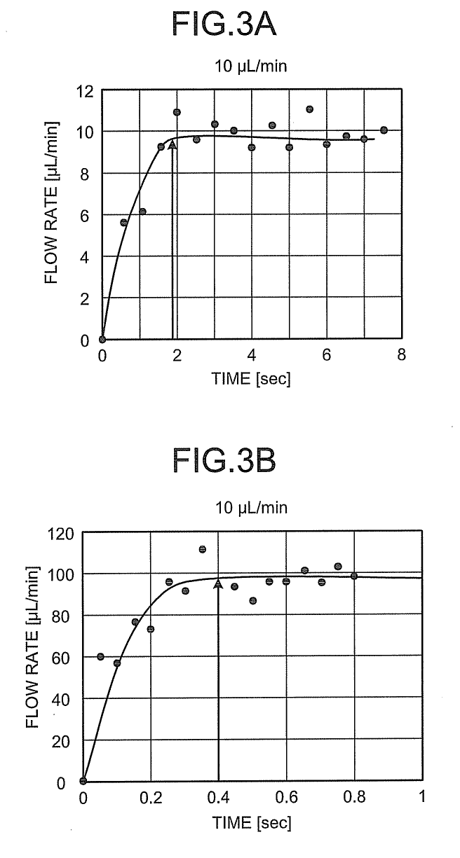

FIGS. 3A and 3B depict test results of a pump operation performance. FIG. 3A depicts an operation performance of a syringe pump when a rated flow amount of the pump is 10 μL/min, and FIG. 3B depicts an operation performance of a syringe pump when a rated flow amount of the pump is 100 μL/min. The horizontal axis represent a lapse time since the pump receives a driving electric signal, and the vertical axis represents a flow rate that the pump gives to a fluid. Any type of a liquid supply pump generates some time difference from when the pump receives a driving electric signal until when the pump starts the operation or until when the flow amount reaches a rated flow amount. The time required until when the pump reaches a steady operation to give a rated flow amount is different depending on a rated flow amount. The time is about 2 seconds in FIG. 3A, and about 0.4 second in FIG. 3B. It is not possible to maintain a constant amount of a solution supplied until when the pump reaches the steady operation.

When an inspection item of a specimen is determined, rated flow amounts of the specimen pump 15 and the first reagent pump 14 are determined to satisfy a predetermined mixture rate. Each pump has an own value of a time required to reach the steady operation to give a certain rated flow amount, and an own value of an amount of the solution supplied until the steady operation is reached. According to the system that mixes the specimen and the reactive reagent at a constant rate by continuous supply of the liquid using the fine flow path 1 like in the present invention, a mixture rate is uncertain at the solution part mixed before both the specimen pump 15 and the first reagent pump 14 reach the steady operation, and at the solution part mixed before the second reagent pump 34 reaches the steady operation. Therefore, these solution parts need to be separated from the fine flow path 1. The amount of the uncertain mixture solution until when the mixture rate is stabilized depending on the driving operation characteristics of the specimen pump 15, the first reagent pump 14, and the second reagent pump 34 is determined by a measuring item. Therefore, the uncertain mixture solution can be efficiently separated from the fine flow path 1 by controlling the driving time corresponding to the first suction pump 16 and the second suction pump 36 as separation mechanisms of separating the uncertain mixture solution from the fine flow path 1. As a result, the specimen inspecting apparatus 500 using an extremely small amount of a specimen can be provided.

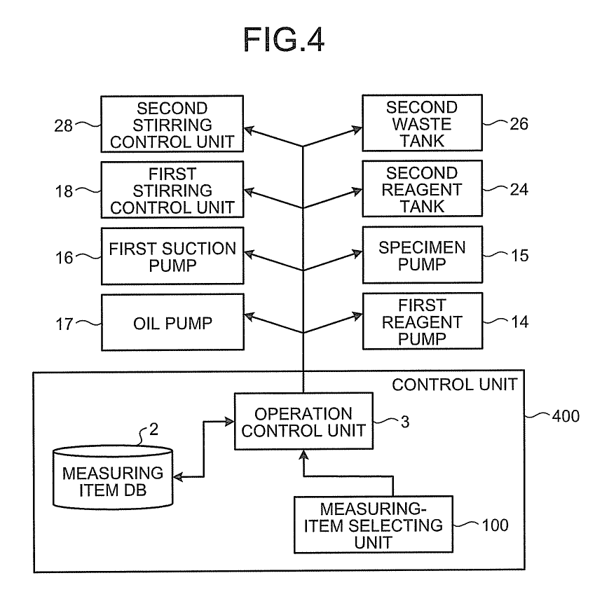

FIG. 4 is a block diagram illustrating a functional configuration of the control unit 400. Parts corresponding to those in FIG. 2 are denoted by like reference numerals, and redundant explanations thereof will be partially omitted.

As shown in FIG. 4, the control unit 400 includes a measuring-item selecting unit 100, a measuring item database (DB) 2 as a storage unit, and an operation control unit 3. The measuring-item selecting unit 100 inputs an item of a specimen to be inspected, to the operation control unit 3 by a keyboard or the like. The measuring item DB 2 stores a rated flow amount prescribed to mix the specimen, the first reagent, and the second reagent at a mixture rate corresponding to the measuring item, the driving time of the first reagent pump 14, the specimen pump 15, and the second reagent pump 34 that supply the liquid, and a driving timing of the first suction pump 16 and the second suction pump 36. The operation control unit 3 reads various parameters stored in the measuring item DB 2, and controls the operation time and timings of the liquid supply pump and the suction pump corresponding to the parameters.

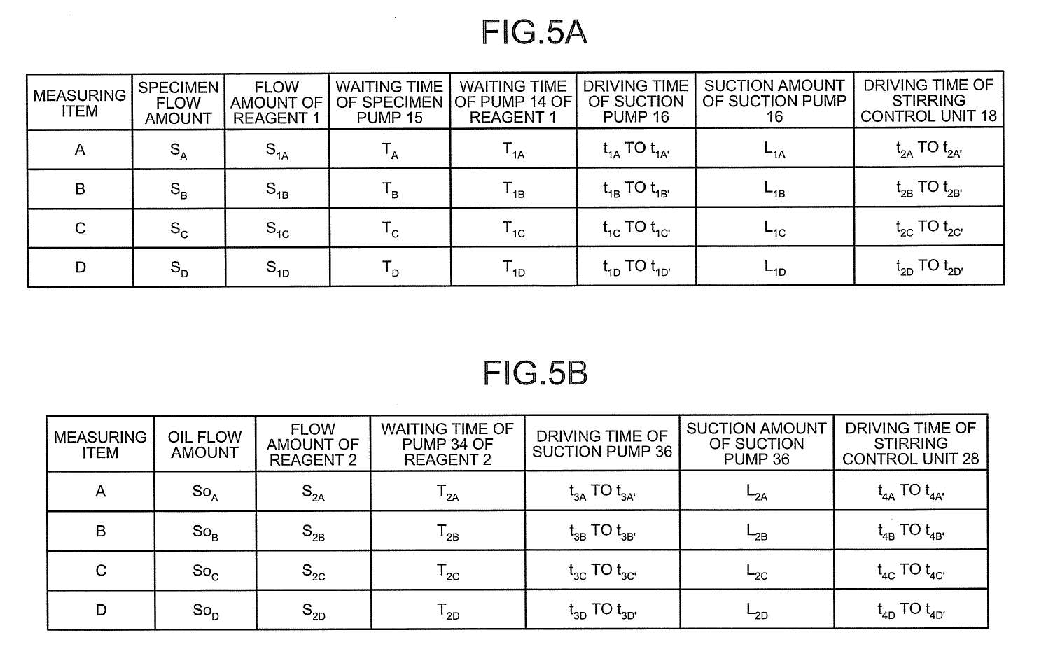

FIGS. 5A and 5B are schematic diagrams illustrating an example of measuring items A, B, C, and D and main parameters for controlling the operation of the specimen inspecting apparatus 500 corresponding to these measuring items stored in the measuring item DB shown in FIG. 4. FIG. 5A is a table relevant to a mixing of the first reagent and the specimen, and the first suction pump 16 that separates the uncertain fixed solution of the mixture solution. The table stores for each measuring item as a parameter, a flow amount of the specimen, a flow amount of the first reagent, waiting times until when the operations of the pumps 14 and 15 are stabilized, the driving time of the first suction pump 16, and the suction amount of the first suction pump 16. FIG. 5B is a table relevant to a mixing of a mixture solution of the first reagent and the specimen and the second reagent, and the second suction pump 36 that separates the uncertain fixed solution of the mixture solution generated. The table stores for each measuring item as a parameter, a flow amount of the oil, a flow amount of the second reagent, the waiting time of the second reagent pump 34, the driving time of the second suction pump 36, and the suction amount of the second suction pump 36.

The driving operation of the liquid supply pump, and the operation of the separating unit that separates the uncertain mixture solution corresponding to the measuring item are explained in detail below with reference to FIG. 4 and FIGS. 5A and 5B.

When the measuring item is input to the measuring-item selecting unit 100, a signal of this measuring item is output to the operation control unit 3. The operation control unit 3 reads various parameters corresponding to the input measuring item, from the measuring item DB 2. The operation control unit 3 supplies an operation signal to the first reagent pump 14 and the specimen pump 15 to supply the liquid to the fine flow path 1 by the rated flow amount and during the time stored in the measuring item DB 2. The first reagent pump 14 and the specimen pump 15 simultaneously start the liquid supplying operation, and control the flow rate to become the rated flow amount. The first reagent and the specimen are mixed within the fine flow path 1.

As explained with reference to FIGS. 3A and 3B, the mixture rate of the mixture solution supplied before both driving operations of the first reagent pump 14 and the specimen pump 15 become constant is uncertain, and therefore, this mixture solution needs to be separated from the fine flow path 1. The amount of the uncertain mixture solution until when the mixture rate is stabilized is determined by the measuring item. Therefore, the waiting times of the first reagent pump 14 and the specimen pump 15 until when their operations reach the rated operation corresponding to the prescribed flow amount determined corresponding to the measuring item are stored in the measuring item DB 2. The operation timing and the suction amount of the uncertain mixture solution that the first suction pump 16 sucks from the fine flow path 1 are stored in the measuring item DB 2 so that the first suction pump 16 sucks the uncertain mixture solution during the time determined by the longer waiting time of the pump waiting for the reaching of the rated operation. When the operation control unit 3 controls the first suction pump 16 following the parameters corresponding to the measuring items, the uncertain mixture solution can be efficiently separated from the fine flow path 1. After the first suction pump 16 finishes the separation of the uncertain mixture solution from the fine flow path 1, the operations of the first reagent pump 14 and the specimen pump 15 become steady, and the mixture rate becomes constant. As a result, the solution can be measured. The operation control unit 3 drives the first stirring control unit 18 at the timing when the liquid of which mixture is constant reaches the first magnet 19 (the stirring bath 20) that performs the stirring. The operation control unit 3 reciprocates the first magnet 19 within the stirring bath 20, thereby promoting the stirring of the specimen and the first reagent.

The operation control unit 3 controls the first reagent pump 14 and the specimen pump 15 to stop supplying the specimen and the first reagent after the specimen and the first reagent are supplied by the amount sufficiently necessary to perform the inspection. This liquid supplying timing is also stored in the measuring item DB 2. When the first reagent pump 14 and the specimen pump 15 stop supplying the liquid, the operation control unit 3 supplies a driving operation signal to the carrying oil pump 17. The oil pump 17 carries the oil until when the first photometric cell 11 is filled with the mixture solution of the first reagent and the specimen. The first stirring control unit 18 continues the stirring based on the vibration operation of the first magnet 19 until when the front end of the carrying oil reaches the position of the first magnet 19. When the front end of the carrying oil reaches the position of the first magnet 19, the operation control unit 3 controls the first stirring control unit 18 to stop vibrating the first magnet 19. By performing the stirring operation corresponding to the measuring item, an unnecessary mixing of the oil and the mixture solution can be prevented. This operation timing of the first stirring control unit 18 is also stored in the measuring item DB 2.

When the first photometric cell 11 is filled after the supply of the mixture solution is finished, the operation control unit 3 stops carrying the oil by controlling the oil pump 17, and the optical inspecting unit 300 performs the optical inspection. After the inspection is finished, the operation control unit 3 controls the oil pump 17 again to start supplying the oil to the fine flow path 1. The flow amount and the liquid supplying timing at this time are also stored in the measuring item DB 2 in relation to the measuring item.

The operation control unit 3 supplies a signal at the timing stored in the measuring item DB 2 so that the second reagent pump 34 starts the liquid supplying operation, when the mixture solution of the first reagent and the specimen are carried to the point of the fine flow path 1 where the fine flow path is branched to the second waste tank 26. When the second reagent pump 34 starts the liquid supplying operation, the oil pump 17 reaches the steady operation to give the rated flow amount. The second reagent pump 34 generates a time difference corresponding to the rated flow amount, by the time when the second reagent pump 34 reaches the steady operation of giving the rated flow amount after receiving an operation starting signal. Therefore, the mixture rate of the first reagent and the second mixture solution supplied until when the second reagent pump 34 reaches the steady operation is uncertain. The time required until when the second reagent pump 34 is stabilized is stored corresponding to the measuring item, in the measuring item DB 2. The timing when the second reagent pump 34 sucks the uncertain mixture solution and the suction amount are stored corresponding to this time, in the measuring item DB 2. The operation control unit 3 controls the sucking operation of the second suction pump 36 based on the stored information. The operation mechanism of the second suction pump 36 is similar to that of the first suction pump 16. When the second reagent pump 34 reaches the rated operation, the operation control unit 3 controls the second suction pump 36 to stop the sucking operation. The oil pump 17 and the second reagent pump 34 continue the liquid supplying operation. When the specimen and the second reagent are supplied by the amount sufficiently necessary to perform the subsequent inspection, the operation control unit 3 controls the second reagent pump 34 to stop supplying the liquid, and controls the oil pump 17 to continue the driving operation. When the second photometric cell 21 is filled with the mixture solution, the operation control unit 3 controls the oil pump 17 to stop the driving operation, and the optical inspecting unit 300 performs the optical inspection. After the optical measuring is finished, the specimen inspecting apparatus 500 finishes the inspection.

While the mechanism of storing the operation timings in the measuring item DB 2 and driving various pumps corresponding to these timings is explained above, the mechanism is not limited to this. For example, the following mechanism can be used. The mechanism stores in the measuring item DB 2 the time required to reach the steady state when the flow amount is at the rated flow amount. In the mechanism, the operation control unit 3 can calculate the timing of the sucking operation and the suction amount of the uncertain mixture solution, corresponding to the time and the flow amount until when the steady state corresponding to the measuring item to be measured reaches.

Furthermore, to more accurately separate the uncertain mixture solution into the first and second waste tanks 6 and 26, the operation control unit 3 can store in the measuring item DB 2 parameters of detailed driving operations of the first and second suction pumps 16 and 36 corresponding to the measuring item as well as the operation timings, and can perform the control corresponding to the stored parameters. The parameters of the driving operation indicate levels to which the first and second suction pumps 16 and 36 decrease the pressures within the first and second waste tanks 6 and 26.

Further, the rubber sheet 161 and a rubber sheet 261 are not limited to the material of rubber and can be any material as long as the material has elasticity in response to stress. A member forming the fine flow path 1 and the liquid supply tanks 4, 5, 7, and 24 and the first and second waste tanks 6 and 26 can be integrally formed with the mixing cartridge 200, or can be formed separately.

Based on the above mechanism, the liquid supply pump can be controlled corresponding to the measuring item, and the uncertain mixture solution of which mixture rate is not efficiently stable by the amount corresponding to the measuring item can be separated from the fine flow path 1. As a result, the amounts of the specimen and the reactive agent necessary for the inspection can be more decreased. The specimen inspecting apparatus 500 capable of inspecting in high precision an extremely small amount of the specimen and the reactive agent efficiently using the specimen and the reactive agent can be provided.

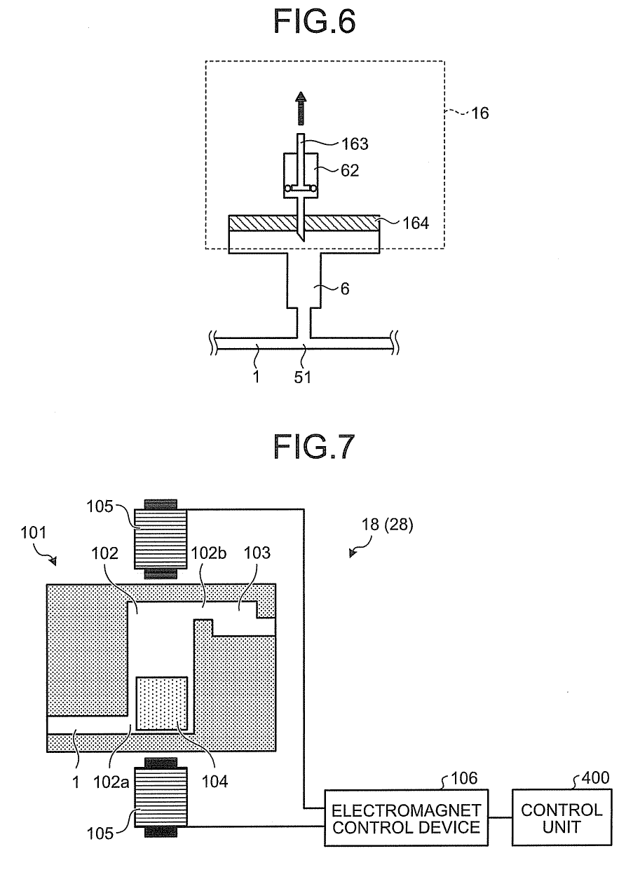

FIG. 6 depicts a separation mechanism extracted from the specimen inspecting apparatus 500. In the first embodiment, the sucking mechanism using the syringe pump is used for the first suction pump 16.

As shown in FIG. 6, there is a rubber seal (rubber sheet) 164 fixed to seal one end of the first waste tank 6. The first waste tank 6 includes a pressure chamber 162 reaching the first waste tank 6 penetrating through the rubber seal 164, and a sucking mechanism 163 arranged in the pressure chamber 162 and adjusting the pressure within the pressure chamber 162 by vertical reciprocation. Based on the pressure adjustment performed by the sucking mechanism 163, the solution having an uncertain mixture rate is separated into the first waste tank 6.

A material of the rubber seal 164 is not particularly limited, and any material having the performance capable of using the suction system of the sucking mechanism 163 can be used. The rubber seal 164 used is required to have the performance capable of maintaining sealing performance to the extent that the solution stored in the first waste tank 6 and air present in surplus space are not leaked out to the outside when the syringe string is pulled out. In the specimen inspecting apparatus 500, the fine flow path 1 and the mixing cartridge 200 of various tanks communicated to the fine flow path 1 can be abandoned after being used to inspect each specimen. In this case, the specimen is prevented from being leaked out from an abandoned part corresponding to a medical waste, thereby avoiding generation of a trouble in safety.

So long as these performances are maintained, the sucking mechanism 163 does not need to be limited to the sucking based on the syringe structure. Any mechanism capable of setting the pressure within the first waste tank 6 to a negative pressure in advance can be used.

The separating unit according to the first embodiment can be used for the second suction pump 36 as well as the first suction pump 16.

A second embodiment of the present invention is explained next with reference to FIG. 7 to FIG. 15. Parts similar to those of the first embodiment are denoted by like reference numerals, and explanations thereof will be omitted. A part of a configuration of the mixing cartridge 200 according to the second embodiment is different from the configuration of the mixing cartridge 200 according to the first embodiment.

FIG. 7 is a schematic diagram illustrating the configuration of a stirring apparatus 101 of the mixing cartridge 200 according to the second embodiment. As shown in FIG. 7, the stirring apparatus 101 as a stirring unit includes a stirring bath 102 and a bubble trap 103 in the fine flow path 1. The stirring apparatus 101 includes a material not shielding a magnetic field. In FIG. 7, force of gravity is applied from above the paper surface downward.

The stirring bath 102 is a space in which the stirring apparatus 101 stirs a mixture solution of the first reagent and the specimen (or a mixture solution of the mixture solution and the second reagent) introduced from a solution entrance 102a of the fine flow path 1 in the stirring apparatus 101, based on electromagnetic force of the first stirring control unit 18 (or the second stirring control unit 28), and a stirrer 104 is arranged in the stirring bath 102. The stirring bath 102 has a cylindrical shape, and a largest size of this shape is larger than an internal diameter. The internal diameter of the stirring bath 102 is smaller than a largest size (a diagonal line between the upper surface and the lower surface, when the stirrer 104 has a cylindrical shape) of the stirrer 104. With this arrangement, the stirrer 104 can be prevented from rotating within the stirring bath 102.

The stirrer 104 is formed by a permanent magnet or a ferromagnetic material such as iron, and is also protected by a material (such as fluorocarbon resin) not affecting a contacted aqueous solution. When the material of the stirrer 104 is a permanent magnet, the stirrer 104 has preferably a cylindrical shape. When the material of the stirrer 104 is a ferromagnetic material, the stirrer 104 has preferably a cylindrical shape or a spherical shape.

A pair of electromagnets 105 constituting the first and second stirring control units 18 and 28 is arranged to sandwich the stirring bath 102 in parallel with a height direction of the stirring bath 102. The pair of the electromagnets 105 constituting the first and second stirring control units 18 and 28 is arranged coaxially with the stirring bath 102, and is arranged so that magnetic field generation directions are vertically opposite to each other. When one stirring bath 102 is used, a center axis of the pair of the electromagnets 105 constituting the first and second stirring control units 18 and 28 coincides with the center axis of the stirring bath 102. When the stirrer 104 is a permanent magnet, the number of the electromagnets 105 constituting the first and second stirring control units 18 and 28 can be one to cause the stirrer 104 to perform a reciprocal movement. However, in this case, magnetic force given to the stirrer 104 decreases, and mixing efficiency decreases.

The bubble trap 103 is provided at the downstream of a solution exit 102b sending out the solution stirred in the stirring bath 102, and functions as a bubble removing mechanism that removes bubbles generated by the stirring operation of the stirrer 104. As shown in FIG. 7, the bubble trap 103 has a larger diameter than that of the solution exit 102b, and a part of the bubble trap 103 is formed at a higher position than the solution exit 102b. By setting a larger diameter of the bubble trap 103 than the diameter of the solution exit 102b, the moving speed of the solution in the bubble trap 103 is delayed, and the bubbles contained in the mixture solution are pooled at an upper part of the bubble trap while the solution passes through the bubble trap 103. To increase the effect of further removing the bubbles, the control unit 400 can temporarily stop or decelerate the liquid supply when the solution stirred in the stirring bath 102 reaches the bubble trap 103.

The bubble removing mechanism is not limited to have a configuration of the bubble trap 103 shown in FIG. 7, but can also use a vapor-liquid separation membrane.

A sequence that the operation control unit 3 of the control unit 400 operates the first and second stirring control units 18 and 28 is explained next.

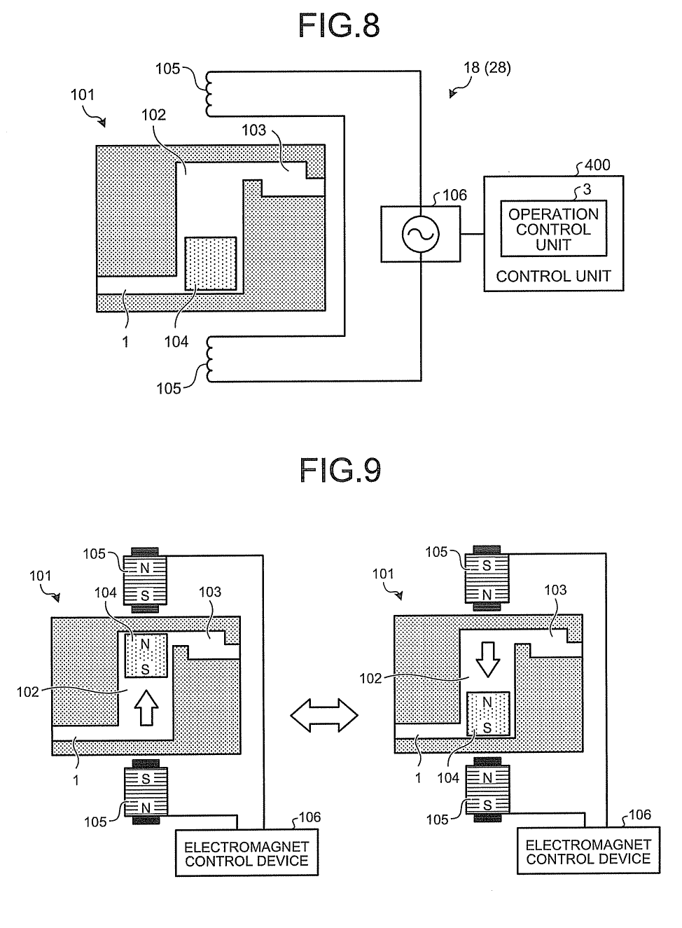

FIG. 8 is a schematic diagram illustrating one example of a circuit configuration of the first and second stirring control unit 18 and 28, and FIG. 9 is a schematic diagram illustrating the stirring apparatus 101 when in operation. FIG. 8 and FIG. 9 depict the case of using a permanent magnet as the stirrer 104. As shown in FIG. 8, the pair of the electromagnets 105 of the first and second stirring control units 18 and 28 is connected in series.

As shown in FIG. 8, the first and second stirring control units 18 and 28 include an electromagnet control device 106 capable of adjusting a current and a frequency. The operation control unit 3 of the control unit 400 controls the electromagnet control device 106 so that an alternate current of a constant frequency is passed to a circuit. In the second embodiment, when the operation control unit 3 controls the electromagnet control device 106, an alternate current of a constant frequency is passed to the circuit, so that the electromagnets 105 generate magnetic force. Consequently, magnetic force generation directions of the pair of the electromagnets 105 become vertically opposite.

As shown in FIG. 9, when the operation control unit 3 controls the power source of the electromagnet control device 106 to pass an alternate current of a constant frequency to the circuit so that the electromagnet 105 generates magnetic force, the stirrer 104 receives attracting force or repulsive force from the electromagnets 105, and moves within the stirring bath 102. Because the electromagnet control device 106 applies an alternate current to the electromagnets 105, directions of the current are changed over corresponding to the applied frequency. As a result, magnetic poles of the electromagnets 105 are changed over, and the stirrer 104 can be reciprocally moved within the stirring bath 102. Based on the reciprocal movement of the stirrer 104 within the stirring bath 102, the first reagent and the specimen (or the mixture solution and the second reagent) can be mixed uniformly during a short time.

While an alternator is used as the power source of the electromagnet control device 106 in FIG. 8, a waveform of the current is not particularly limited. A few hertz to dozens of hertz of frequencies can be selected. When the operation is synchronized, the pair of the electromagnets 105 can be independently controlled.

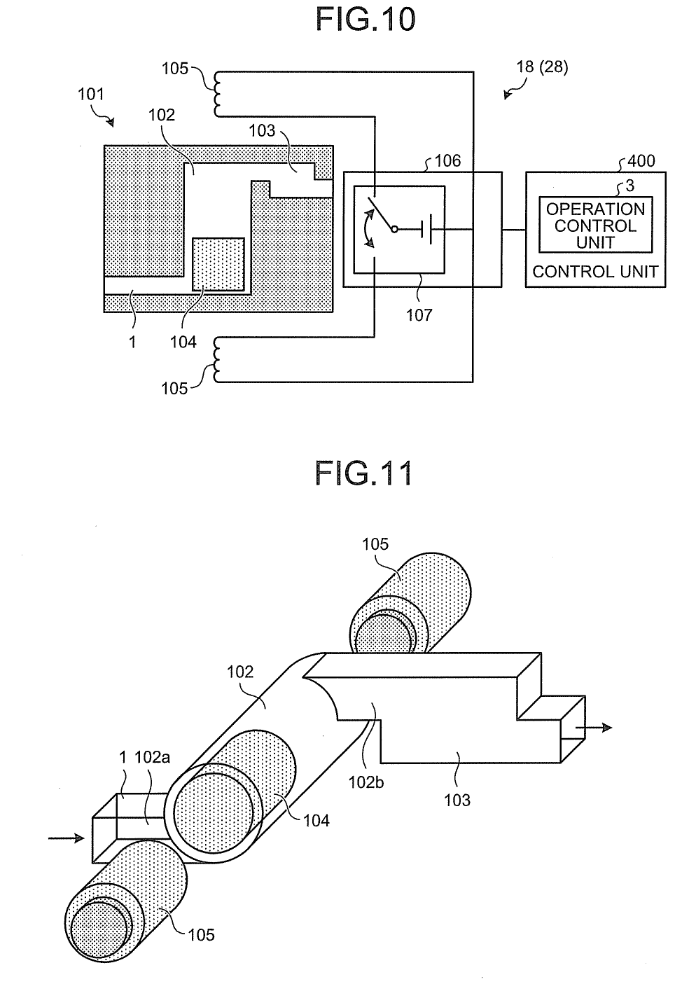

A use of the ferromagnetic material as the stirrer 104 is explained next with reference to FIG. 10. As shown in FIG. 10, when the ferromagnetic material is used as the stirrer 104, the operation control unit 3 controls a switch 107 included in the electromagnet control device 106, thereby alternately operating the pair of the electromagnets 105 to move the stirrer 104 of the ferromagnetic material by attracting force and reciprocally move the stirrer 104 within the stirring bath 102. A few hertz to dozens of hertz of switching frequencies can be selected for the switch 107. When the operation is synchronized, the pair of the electromagnets 105 can be independently controlled.

Preferably, the starting timing of the driving of the stirring apparatus 101 is after the stirring bath 102 is filled with the first reagent and the specimen (or the mixture solution and the second reagent). The control unit 400 can control the determination about whether the stirring bath 102 is filled with the aqueous solution, based on a time calculated from the capacity and the liquid supply speed of the stirring bath 102. Alternatively, a liquid surface sensor can be arranged in the stirring bath 102, and the control unit 400 can monitor.

As explained above, according to the second embodiment, the stirrer arranged in the stirring bath provided in the flow path and accommodating the mixture solution of the first solution and the second solution is reciprocally moved in the stirring bath by control of electromagnetic force to stir the mixture solution. With this arrangement, the two liquids can be efficiently mixed without using a rotation mechanism configured by a motor or the like. As a result, an extremely small amount of a solution can be uniformly mixed in a short time highly efficiently and in a compact, integratable, and low-cost configuration.

In the second embodiment, as shown in FIG. 7, while a longitudinal direction of the stirring bath 102 is arranged in the direction of force of gravity, the arrangement is not limited to this. For example, as shown in FIG. 11, the longitudinal direction of the stirring bath 102 can be arranged perpendicularly to the direction of force of gravity.

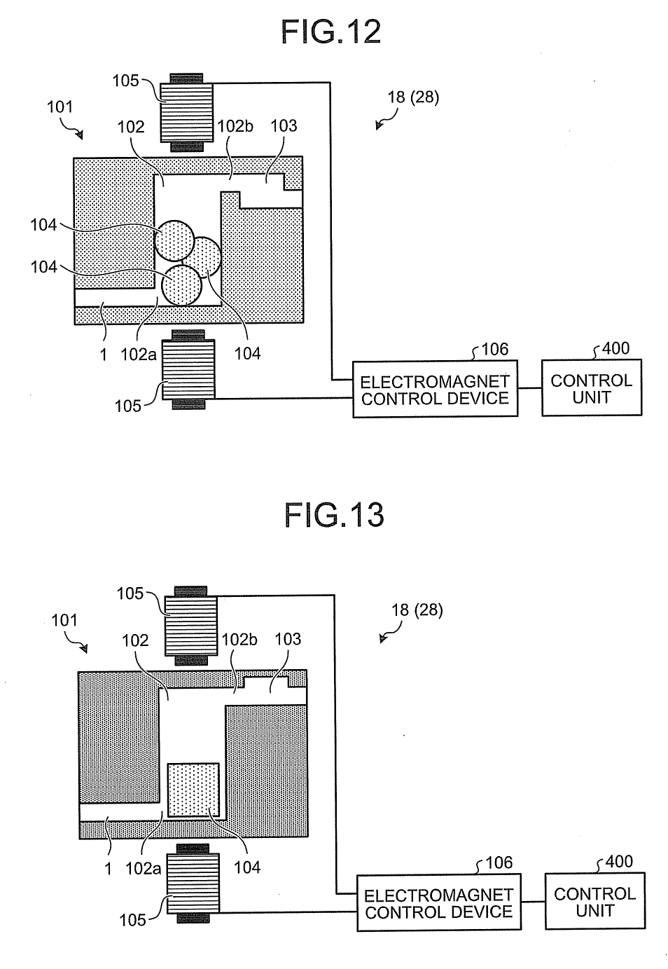

In the second embodiment, as shown in FIG. 7, while one stirrer 104 is arranged in the stirring bath 102, the number of the stirrer is not limited to this. For example, as shown in FIG. 12, plural stirrers 104 can be arranged in the stirring bath 102.

The shape of the bubble trap 103 is not limited to the shape shown in FIG. 7, and various other shapes can be considered. For example, in a shape as shown in FIG. 13, a diameter of the bubble trap 103 is set larger than that of the solution exit 102b, and a part of the bubble trap 103 is formed at a higher position than the solution exit 102b.

A vertical positional relationship between the solution entrance 102a and the solution exit 102b can be reversed.

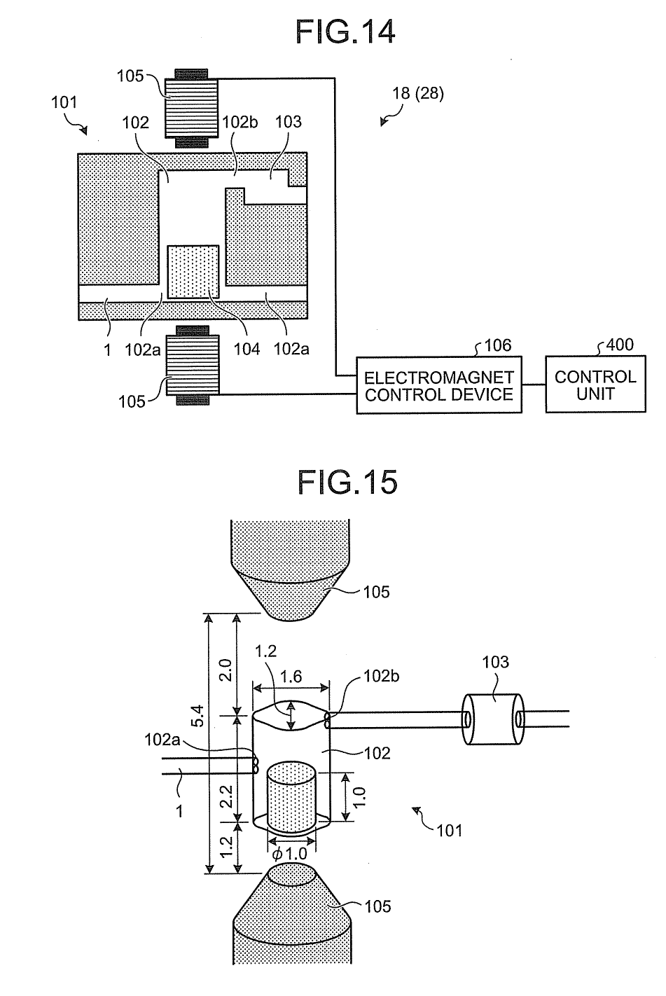

In the second embodiment, as shown in FIG. 7, while the two liquids merge at the upstream of the solution entrance 102a and the merged liquids reach the stirring bath 102 in a laminar flow state, the configuration is not limited to this. For example, as shown in FIG. 14, the solution entrance 102a can be provided at two positions in the stirring bath 102 assuming the mixture of the two liquids. More solution entrances 102a can be provided in the stirring bath 102 corresponding to the number of solutions to be mixed.

Examples are explained below. FIG. 15 is a schematic diagram illustrating one example of the stirring apparatus 101. A main body of the stirring apparatus 101 shown in FIG. 15 is formed using an acrylic resin. The stirring apparatus 101 has a major axis 1.6 millimeters, a minor axis 1.2 millimeters, and a height 2.2 millimeters. The stirrer 104 (the diameter and height thereof are 1 millimeter) made of a nickel-coated neodymium magnet is arranged in the stirring bath 102. The solution entrance 102a (with a diameter of 0.4 millimeter) is connected to a position of about 1 millimeter from the lower end, and the solution exit 102b (with a diameter of 0.4 millimeter) is connected to an upper end of the stirring bath 102.

At the upstream of the solution entrance 102a, a merging part (not shown) of the two liquids is present, and two liquid supply pumps (not shown) are present at the higher upstream. The two liquids supplied by the pump reach the stirring bath 102 in a laminar state. The bubble trap 103 (with a diameter of 1 millimeter) is present at the downstream of the solution exit 102b, and an optical cell (not shown) is present at the downstream thereof.

The pair of the electromagnets 105 is arranged at 2 millimeters upstream of the stirring bath 102, and at 1.2 millimeters downstream of the stirring bath 102, respectively. The pair of the electromagnets 105 is arranged at an interval of 5.4 millimeters. As a result, the pair of the electromagnets 105 generates force of 1 milliNewton (mN) in a state that the stirrer 104 is separated most. In this case, considering the influence of force of gravity, the lower electromagnet 105 is arranged nearer to the stirrer 104. The pair of the electromagnets 105 is connected in series, and are connected to an electromagnet control device (not shown) capable of adjusting a current and a frequency.

In the above configuration, the solutions are mixed in the following conditions.

A flow rate of the two liquids in total is 50 μL/min, and a reciprocating speed of the stirrer 104 is 20 hertz. Velocity of the two liquids is adjusted to 6.4 centiPoises (cP), and a pigment is introduced into one of the liquids. The liquids are mixed continuously during the liquid supply, and a result of the mixing is observed using a charge couple device (CCD) camera in an observation flow path. An image observed by the charge couple device (CCD) camera is processed, and a mixture rate σ is calculated. The following equation shows the mixture rate σ.

C: A light intensity profile of a pigment in a flow path to be evaluated

C_{∞}: A light intensity profile of a pigment in a completely mixed state

C₀: A light intensity profile of a pigment before mixing The mixture rate σ becomes 100% when C=C₂₈, that is, when the pigment in the flow path is completely uniform.

In this example, a red pigment liquid-solution and an achromatic solution are introduced into the flow path. A data processing is performed by setting a pigment distribution (two-laminar flow state) in the flow path when the stirring apparatus 101 is not operated is set to C₀, and by setting a state that a pigment distribution in the flow path is uniform by completely dispersing the pigment is set to C_{∞}.

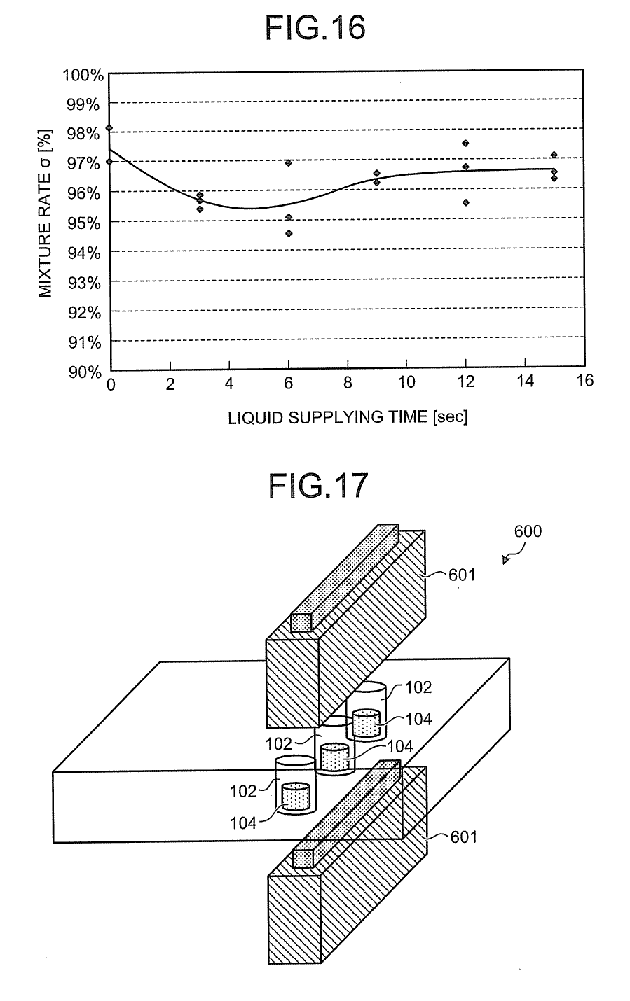

FIG. 16 is a graph of a result of the mixing. Obtaining of an image is started when the observation flow path is filled with the solution. Thereafter, an image is obtained at every 3 seconds, and the mixture rate σ is calculated. A similar inspection is repeated by three times, and obtained data are plotted in the graph. As a result of the inspection, it becomes clear that when the liquids are continuously mixed at the liquid supply speed of 50 μL/min and at the mixing speed of 20 hertz in the configuration shown in FIG. 15, the mixture rate reaches 95% or higher from the initial period of the mixing.

A third embodiment of the present invention is explained next with reference to FIG. 17. Like parts as those in the first embodiment or the second embodiment are denoted by like reference numerals, and explanations thereof will be omitted.

FIG. 17 is a schematic diagram illustrating a stirring apparatus 600 according to the third embodiment. As shown in FIG. 17, the stirring apparatus 600 includes the plurality of stirring baths 102 connected in a row having the stirrers 104 arranged to stir a solution. A pair of electromagnets 601 constituting the first and second stirring control units 18 and 28 is arranged in parallel with a height direction of the stirring baths 102 to sandwich all the stirring baths 102.

As explained above, according to the third embodiment, by driving the stirrers within the stirring baths by the pair of electromagnets, a simultaneous stirring operation can be performed within the stirring baths. Therefore, the devices can be easily made compact and integrated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A specimen inspecting apparatus comprising:
a member that forms a flow path;
a first solution supplying unit that supplies a first solution containing a specimen to the flow path;
a selecting unit that selects a measuring item of the specimen to be inspected;
a second solution supplying unit that supplies a second solution corresponding to the measuring item to the flow path;
a separating unit that can separate a part of a mixture solution with which the first solution and the second solution in the flow path;
an operation control unit that controls the separating unit corresponding to a measuring item selected by the selecting unit, to separate a portion of the mixture solution of which mixture rate is not constant; and
a inspecting unit that is communicated to the flow path at a downstream position of the separating unit, and that irradiates light to the mixture solution except the separated mixture solution to inspect the specimen.

2. The apparatus according to claim 1, wherein the separating unit includes
a tank that communicates to a flow path branched from the flow path, and
a pressure control unit that controls a pressure within the tank, wherein
the separating unit separates a part of the mixture solution from the flow path by changing the pressure.

3. The apparatus according to claim 1, wherein the operation control unit includes a storage unit that stores time information to operate the separating unit for each measuring item to be inspected, and
the apparatus searches from the storage unit time information corresponding to the measuring item selected by the selecting unit, and controls the separating unit based on the time information.

4. The apparatus according to claim 2, wherein the pressure control unit is a syringe pump.

5. The apparatus according to claim 2, wherein the pressure control unit includes
a rubber sheet that is fixed to a part of the tank to block the part,
a pressure chamber that reaches the tank penetrating through the rubber sheet, and
a sucking mechanism that is arranged within the pressure chamber, and that adjusts a pressure within the pressure chamber.

6. The apparatus according to claim 1, further comprising a stirring unit that stirs the mixture solution before entering the inspecting unit.

7. The apparatus according to claim 6, wherein the stirring unit includes
a stirring bath that is provided in the flow path and accommodates the mixture solution,
a stirrer that is arranged in the stirring bath, and
a stirring control unit that reciprocates the stirrer within the stirring bath to stir the mixture solution by control of electromagnetic force.

8. The apparatus according to claim 7, wherein the stirring bath has a cylindrical shape, an internal diameter of the stirring bath is smaller than a maximum size of the stirrer, and a longitudinal direction of the stirring bath is larger than the internal diameter.

9. The apparatus according to claim 8, wherein
the stirrer is formed by a permanent magnet having a cylindrical shape, and
the stirring control unit reciprocates the stirrer within the stirring bath by changing over between magnetic force directions of a pair of electromagnets provided at ends of a longitudinal direction of the stirring bath, respectively.

10. The apparatus according to claim 8, wherein
the stirrer is formed by a ferromagnetic material having a cylindrical shape or a spherical shape, and
the stirring control unit reciprocates the stirrer within the stirring bath by alternately operating a pair of electromagnets provided at ends of a longitudinal direction of the stirring bath, respectively.

11. The apparatus according to claim 7, wherein the stirring unit further includes a bubble removing unit that removes bubbles generated by the reciprocal movement of the stirrer from the mixture solution, at more downstream side of the mixture solution than the stirring bath.

12. The apparatus according to claim 7, wherein
a plurality of the stirring baths and the stirrers are provided, and
the stirring control unit controls reciprocal movements of the stirrers.

13. A stirring apparatus comprising:
a stirring bath that is provided in a flow path through which a first solution containing a specimen and a second solution corresponding to a measuring item of the specimen to be inspected flow, and that accommodates a mixture solution between the first solution and the second solution;
a stirrer that is arranged within the stirring bath; and
a stirring control unit that reciprocates the stirrer within the stirring bath by control of electromagnetic force, thereby stirring the mixture solution.

14. The apparatus according to claim 13, wherein the stirring bath has a cylindrical shape, an internal diameter of the stirring bath is smaller than a maximum size of the stirrer, and a longitudinal direction of the stirring bath is larger than the internal diameter.

15. The apparatus according to claim 14, wherein
the stirrer is formed by a permanent magnet having a cylindrical shape, and
the stirring control unit reciprocates the stirrer within the stirring bath by changing over between magnetic force directions of a pair of electromagnets provided at ends of a longitudinal direction of the stirring bath, respectively.

16. The apparatus according to claim 14, wherein
the stirrer is formed by a ferromagnetic material having a cylindrical shape or a spherical shape, and
the stirring control unit reciprocates the stirrer within the stirring bath by alternately operating a pair of electromagnets provided at ends of a longitudinal direction of the stirring bath, respectively.

17. The apparatus according to claim 13, wherein the stirring unit further includes a bubble removing unit that removes bubbles generated by the reciprocal movement of the stirrer from the mixture solution, at more downstream side of the mixture solution than the stirring bath.

18. The apparatus according to claim 13, wherein
a plurality of the stirring baths and the stirrers are provided, and
the stirring control unit controls reciprocal movements of the stirrers.
